(19) United States
(12) Patent Application Publication
(10) Pub. No.: US 2009/0078788 A1
(43) Pub. Date: Mar. 26, 2009

(54) Sprinkler Head

(76) Inventor: Tony Holmes, New South Wales (AU)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 12/225,006

(22) PCT Filed: May 11, 2007
(86) PCT No.: PCT/AU2007/000634

§ 371 Date: Sep. 10, 2008

(30) Foreign Application Priority Data
May 15, 2006 (AU) 2006902580
Jan. 8, 2008 (AU) 2006904207

(51) Int. Cl. B05B 3/04

(52) U.S. Cl. 239/222.17

(57) ABSTRACT

A sprinkler device is provided comprising a central body, a deflector assembly and at least one vane, directly or indirectly connected to the deflector assembly. The central body incorporates a nozzle in communication with a water inlet which is directed towards the deflector assembly. The deflector assembly is loosely coupled to the body and located in use, on a path of the jet projecting from the nozzle to deflect the jet as a series of droplets. The deflector assembly also has one or more substantially radially extending spray grooves which are acted on by the jet to rotate and roll the deflector assembly causing the jet to be broken into droplets. The deflector assembly is also provided with one or more vanes connected to and extending in a direction having a radial component relative to the deflector assembly, whereby the one or more vanes interact with surrounding air when the deflector assembly rotates to slow rotation and fan the air outwardly to help propel the droplets.

The present invention relates to irrigation sprinklers and in particular, the invention provides a sprinkler head of the wobbling spray cone type which employs modifications to the spray cone to modify rotation of the spray cone and or trajectory of water dispersed by the sprinkler head.

### BACKGROUND TO THE INVENTION

Off centre rotary action sprinklers have been widely used in the irrigation industry for over twenty years and are generally referred to as ‘Wobblers’ because of the shaking motion that they create when rotating during operation.

This wobbling motion is not desirable but is acceptable in the general use of the wobbler sprinklers because they are normally secured to a large pipe network of centre pivot or linear move travelling irrigators, which substantially dampens the vibration created by the off-centre rolling action.

An advantage derived from the existence of off balance rotational forces is that they slow the rotational speed of the spray cone allowing grooves in the deflecting surface of the spray cone to create large droplets which are directed to the outer perimeter of the sprinkler's distribution pattern. Smaller droplets which form as the spray cone rotates from groove to groove fall to ground on the inner area of the sprinkler's distribution pattern and the combination of large and small droplets create a desirable evenness of water applied over the wetted area.

Compared to other sprinklers available for commercial and agricultural irrigation, wobbling sprinklers operate extremely well in low pressure applications which is highly desirable as it leads to lower operating costs for pump operated irrigation systems.

Wobbling sprinklers work best when they are fitted to a secure pipework or base which stabilises this wobbling or, vibrating motion. Sprinklers fitted to bases without adequate stability are subject to vibrations that fracture the water jet exiting the nozzle before it reaches the spray cone groove causing excessive water to be applied to the inner radius of the spray pattern directly around the sprinkler and significantly reduces the wetted area.

These characteristics have limited the wider use of this type of sprinkler in other applications, such as the domestic and nursery industry, because a suitable base or stand rarely has sufficient mass or stability to dampen the vibration caused by the offset rotary action of the wobbling spray cone.

### SUMMARY OF THE INVENTION

A sprinkler device is provided, comprising:

i) a central body incorporating a nozzle in communication with a water inlet;

ii) a deflector assembly having at least one substantially, radially extending spray groove, the deflector assembly being loosely coupled to the body and located in use, on a path of a jet projecting from the nozzle.

Preferably, at least one vane is connected to the deflector assembly and extends in a direction having a radial component relative to the deflector assembly.

Preferably also at least two substantially radially extending spray grooves provide different water paths and resultant exit trajectories from the spray head.

In a preferred embodiment, a plurality of vanes are distributed evenly about the deflector assembly. The deflector assembly is preferably coupled to the body via a rolling ring extending around the body and held captive between flanges extending from the body. Deflecting surfaces of the deflector assembly are preferably connected to the rolling ring via connecting columns and preferably comprise a spray cone in which a plurality of radially extending grooves are formed extending from an apex of the cone. The vanes may be mounted directly to the spray cone or to the rolling ring or connecting columns. Preferably, some vanes extend from the spray cone and additional vanes extend from the rolling ring. In the preferred embodiment, flat radial vanes extend from the spray cone and curved generally radial fan vanes extend from the rolling ring, the curved vanes acting as a radial fan drawing air into the sprinkler and creating air flow over the spray cone. There are preferably three flat radial vanes extending from the spray cone and six curved vanes extending from the rolling ring

Preferably also, the deflector assembly is provided with at least two substantially radially extending spray grooves, providing different water paths and resultant exit trajectories from the spray head. In preferred embodiments multiple exit trajectories provide optimum water distribution diameter during various situations and wind conditions. Preferably one water path will have a low angle of trajectory for wind penetration, while the other is suited for greater throw.

In the sprinkler head of the preferred embodiment, with water paths are provided having two different exit trajectories on opposing sides of the spray cone, however it will be recognised that more that two different exit trajectories might be provided in alternative embodiments of the invention. Six spray grooves are provided in the preferred embodiment, three providing one exit trajectory and three providing the other trajectory. It will be recognised that the number of grooves may also vary in alternative embodiments.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF THE DRAWINGS

An embodiment of a sprinkler head will now be described by way of example with reference to the accompanying drawings in which;

FIG. 1 is a sectional elevation of an assembled sprinkler head;

FIG. 2 is a top view of a rolling plate and column component of the sprinkler head of FIG. 1;

FIG. 3 is a detail of a column from the component illustrated in FIG. 2;

FIG. 4 is a sectional elevation of the component of FIG. 2;

FIG. 5 is a bottom view of the component of FIG. 2;

FIG. 6 is a plan and sectional side view of a washer component of the sprinkler head of FIG. 1;

FIG. 7 is a plan and sectional side view of a collar component of the sprinkler head of FIG. 1;

FIG. 8 is a sectional elevation of a base component of the sprinkler head of FIG. 1 with the washer and collar components fitted;

FIG. 9 is a bottom view of the base component of FIG. 8;

FIG. 10 is a bottom view of a spray cone of the deflector assembly of the sprinkler head of FIG. 1;

FIG. 11 is a first sectional side view of the spray cone shown in FIG. 10;

FIG. 12 is a second sectional side view of the spray cone shown in FIG. 10; and

FIG. 13 is a top view of the spray cone shown in FIG. 10.

### DETAILED DESCRIPTION OF A PREFERRED EMBODIMENT OF A SPRINKLER HEAD

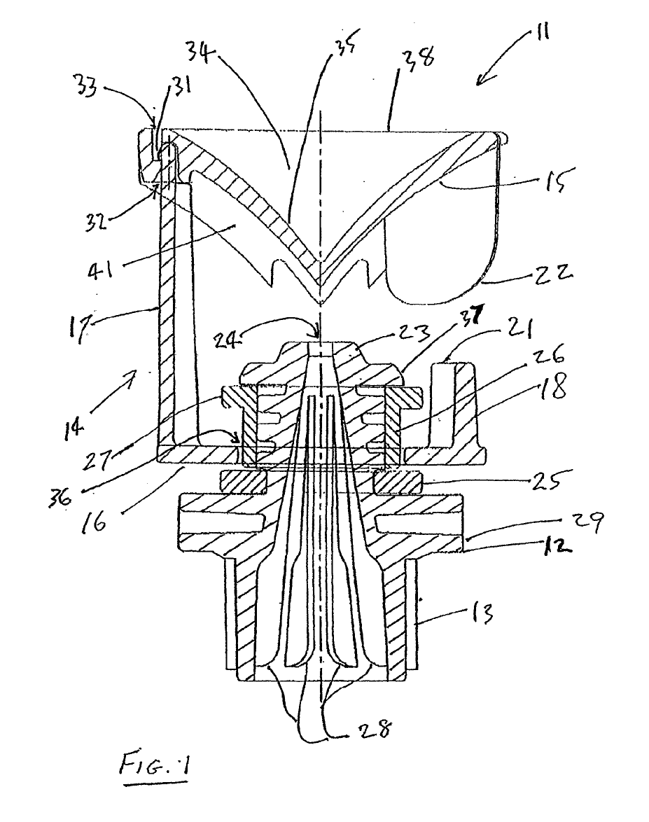

FIG. 1 provides a sectional elevation of a preferred embodiment of a sprinkler head 11, which comprises a base component 12 (see also FIGS. 8 & 9) and a deflector assembly 14. The base component 12 is provided with a male threaded portion 13 for connecting the sprinkler head to a sprinkler base or pipe network and, a central passage 24 extending from the threaded end to the nozzle 23. Flow straightening fins 28 are provided in the passage 24 to reduce turbulence in the jet of water projecting from the nozzle 23. To assist in the tightening of the thread 13 of the base into a cooperating female threaded socket, hexagonal projections 29 provide a set of flats which will receive a spanner to enable tightening and loosening of the base component in a sprinkler base or supply pipe work.

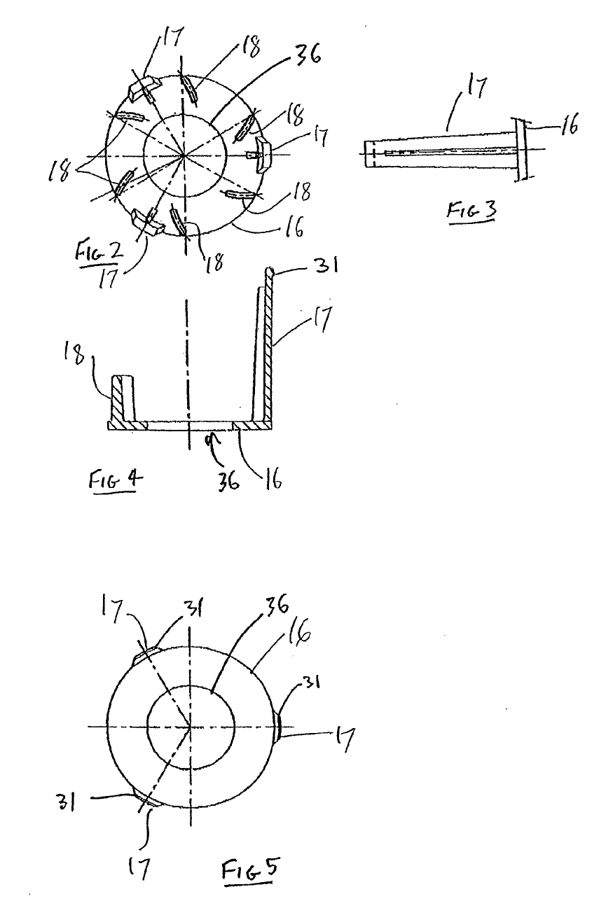

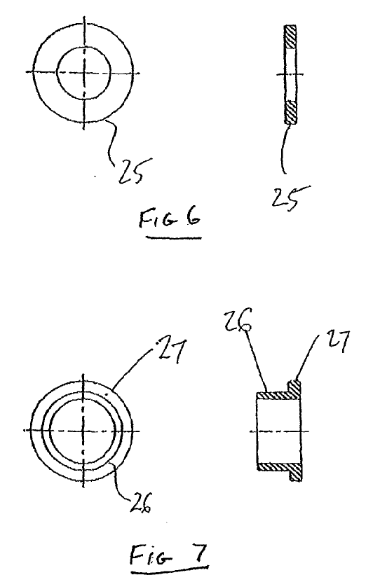

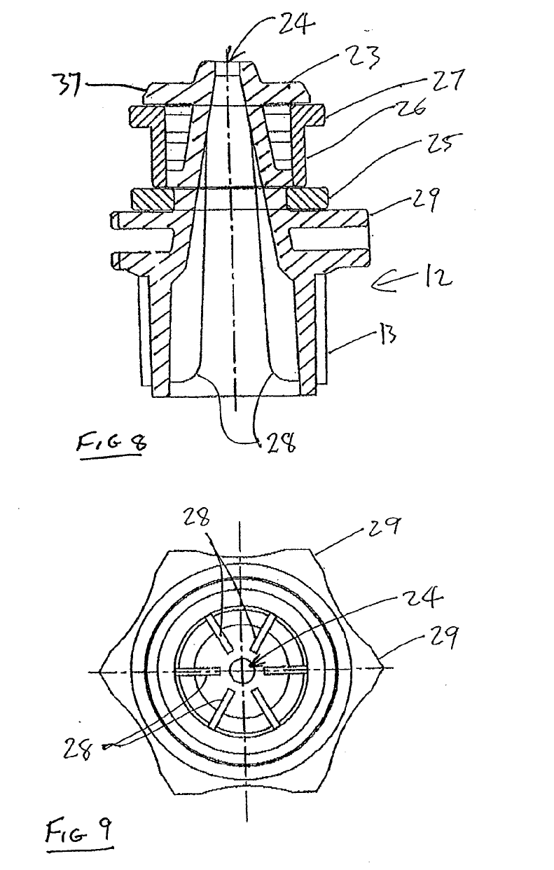

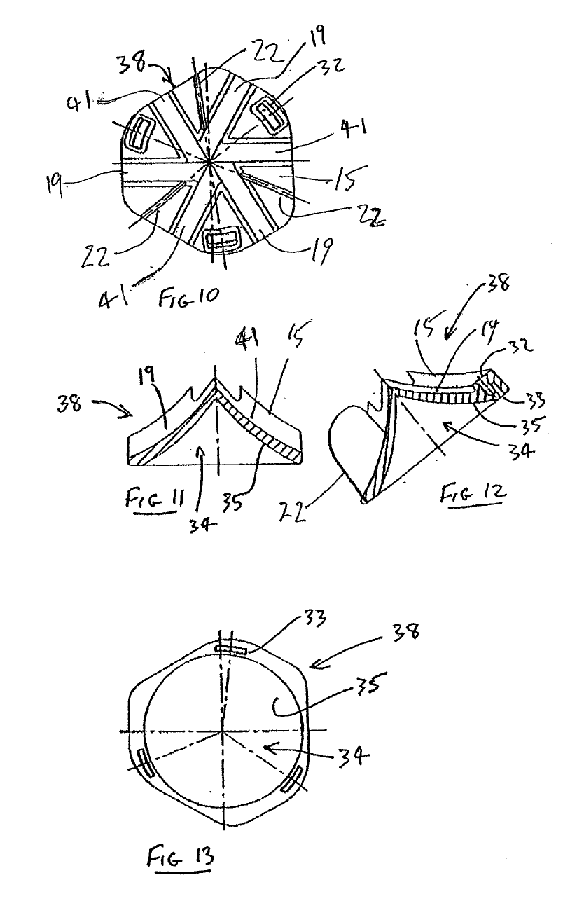

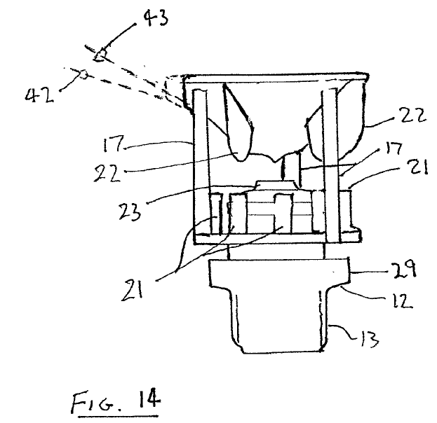

The deflector assembly 14 (see also FIGS. 2, 3, 4, 5, 10, 11, 12 & 13), comprises a conical deflector element or spray cone 38 connected to a rolling ring 16 by a plurality of columns 17. A plurality of deflector groves 19, 41 are formed in the spray cone 38, extending outwardly from the apex as seen in more clearly in FIG. 10. The rolling ring 6 sits around the nozzle 23 of the base component 12 and is captive between a washer forming a lower flange 25 (see also FIG. 6) and an upper flange 27 (see also FIG. 7). A protective sleeve 26, integral with the upper flange 27, extends around the nozzle 23 and provides wear resistance for the rolling ring 16 by reducing the thickness of the conical wall defining surfaces 15 & 34.

The spray cone 38 (see also FIGS. 10, 11, 12 & 13) is made lighter than equivalent deflectors in prior art devices. The reduced mass of the deflector results in an increase in rotational speed under the force of water projected from the nozzle 23.

Curved vanes 18 extend from the upper surface of the rolling ring 16 and collectively form a radial fan (see also FIG. 2) which draws air into the centre of the deflector assembly 14 when the deflector assembly rotates under the force of water projection from the nozzle 23. The inwardly directed air flow created by the radial fan vanes 18 causes air to swirl upwardly around the jet of water projecting from the nozzle 23 to help direct the jet stream from the nozzle 23 onto the surface 15 of the spray cone 38 and to help protect the jet stream from the effects of wind.

Three flat vanes 22 (refer also to FIGS. 10 & 12) extend out of the spray cone 38 and create a fanning effect to push air out of the sprinkler head as the deflector assembly 14 rotates. The combined effect of the curved vanes 18 and the flat vanes 22 is to slow rotation of the deflector assembly 14 counteracting the effect of decreased mass, while creating air flow which protects the jet of water projecting out of the nozzle 23 against fracturing and propels smaller droplets further from the sprinkler to reduce flooding immediately around the sprinkler. The combination of reduced mass without any significant increased rotational speed results in reduced vibration which also reduces the tendency for the jet of water to fracture.

Assembly of the parts of the sprinkler is achieved by placing the washer 25 over the nozzle 23, placing the hole 36 of the rolling plate 16 over the nozzle 23 and then placing the collar comprising the sleeve 26 and flange 27 over the nozzle to retain the rolling plate 16. The washer 25 and the collar 26, 27 are formed of a soft plastics or rubber material which is deformable to stretch over the projecting flange 37 of the nozzle 23 such that once in place, the rolling plate 16 is held captive between the lower flange 25 and the upper flange 27.

The rolling plate 16 is formed of a rigid plastics material and the hole 36 in the rolling plate 16 is slightly larger than the flange 37 of the nozzle 23 to allow it to easily pass over the flange 37.

The spray cone 38 (see also FIGS. 10, 11, 12 & 13) is provided with lower openings 32 and upper openings 33 which are in offset, communication to form an internal step and the distal ends of the columns 17 (see also FIGS. 3 & 4) are provided with a cooperating stepped end portion 31 which snaps into the openings 32 to join the spray cone to the columns.

The sprinkler head 11 makes use of vanes to assist in controlling the rotational speed of the rotating offset spray cone of the sprinkler head, while extending the “throw” of the droplets which potentially results in lower vibration and improved water distribution at low pressure.

The illustrated wobbling sprinkler head is designed for a varying range of applications and is particularly suited to low pressure, low flow and low energy use operations. This wobbling, or offset rotary action sprinkler head has only one moving part which is kept to minimal weight to reduce undesirable vibration characteristics. To counteract the increase in speed that would naturally result from decreased mass, radial fan vanes and flat radial vanes have been added which effectively use air resistance to control the rotational speed of the spray cone 38. The rotating speed of the spray cone is proportional to the water pressure applied to the sprinkler. However, the air resistance caused by the vanes is also proportional to the rotational speed of the spray cone as is the air flow through the head created by the vanes.

By reducing the mass of the rotating offset spray cone, vibration is significantly reduced. It is the spray cone that generates all of the vibration forces created by the sprinkler head because its rotation is offset. However, by reducing the mass of the spray cone, all other things being equal, the rotational speed of the spray cone is increased for a given water pressure setting which in turn reduces the time that the jet of water exiting from the nozzle will be directed at a particular spray cone groove 19 or 41, with which it is temporarily aligned. This causes droplets formed in the spray cone and exiting the sprinkler to be smaller, which in turn reduces the watered diameter.

Additionally, with increased rotational speed, an increased percentage of small droplets created as the water jet passes from groove to groove of the rotating spray cone fall into the inner radius of the sprinkler location near the sprinkler base causing over watering of the inner area of the sprinkler head's coverage. This uneven distribution of water is undesirable however, reduced mass provides the advantage that the free rolling of the spray cone at low pressures is improved.

To overcome excessive rotational speed of the spray cone, six curved vanes 21 acting as turbine fan blades and a further three flat vanes have been located on opposing faces of the rolling plate 16 and the spray cone 38.

The six turbine fan vanes 21 located on the upper surface of the rolling plate 16 perform a duel purpose of creating air resistance to assist with slowing the rotational speed of the spray cone 38 and directing air inward towards the sprinkler nozzle.

Located on the underside of the spray cone 15 are three flat vanes 22. These vanes are in radial alignment with the centre axis of the spray cone and are larger in surface area than the turbine fan vanes (located on the upper surface of the rolling plate 16). The flat radial vanes 22 also travel through a larger diameter than the fan vanes 21 during a normal rotation of the spray cones, creating even greater air resistance when rotating, to further assist with slowing the rotational speed of the spray cone.

These fan vanes 21 and radial vanes 22 assist with the distribution of water on the inner diameters by fanning the smaller water particles away from the sprinkler and by assisting with the generation of larger droplets which will be flung to the outer perimeters of the distribution pattern by slowing the rotational speed of the rolling offset spray cone and therefore allowing the water jet to remain directed at each groove in the spray cone for a fractionally longer period of time on each passing than would otherwise be the case. The turbine fan vanes and radial vanes create a vortex of airflow which assists in the dispersion of droplets away from the sprinkler head. Further, because the overall weight of the spray cone head has been reduced, it is easier to start it rotating with low water pressure.

Two other factors that affect the sprinkler's distribution pattern are turbulence in the water supply entering the sprinkler base and wind conditions. The water turbulence is overcome by the simple addition of stream straightening fins 28 on the inner side of the threaded inlet. Wind conditions affect the performance of all sprinklers but with the rotary turbine vane sprinkler it is desirable that the jet of water exiting the nozzle 23 maintains an unbroken flow until it reaches the groves 19, 41 on the underside of the rotating spray cone 38. In the area immediately surrounding the nozzle exit, a vortex of inward air flow is created by the surrounding rotating curved vanes 21 and flat radial vanes 22. Together these create an isolated environment for the water jet to flow toward the rolling spray cone 38 with minimal effect from external wind conditions. This assists the sprinkler to have a more consistent performance during various outdoor conditions.

Increased water pressures, cause a corresponding increase in rotational speed of the spray cone 38 and in these circumstances, the curved fan vanes and flat radial vanes cooperate to create a degree of air resistance which reduces excessive spinning of the spray cone while simultaneously forming a vortex of airflow to disperse the smaller droplets away from the sprinkler which assists with the even distribution of applied water.

The illustrated sprinkler head is provided with water paths having two different exit trajectories 42, 43 (see FIG. 14) on opposing sides of the spray cone 38. Referring again to FIG. 10, of the six grooves 19, 41 provided, three grooves 41 are shorter than the remaining grooves 19, by virtue of the peripheral shape of the spray cone. The three shorter grooves 41 have a high angle of trajectory 43 for greater throw and the three longer grooves have a lower angle of trajectory 42 for wind penetration. Together these different trajectories assist in achieving the desired water application rate and distribution under various wind conditions.

The design factors described above allow the reduced weight, ‘vaned’, wobbler sprinkler head to be fixed to lower mass bases or water distribution devices which will still adequately support the sprinkler for a broad range of applications with varying water pressures, and potentially reduced power and energy requirements.

It will be appreciated by persons skilled in the art that numerous variations and/or modifications may be made to the sprinkler head as shown in the specific embodiments without departing from the spirit or scope of the sprinkler head as broadly described. The present embodiments are, therefore, to be considered in all respects as illustrative and not restrictive.

1. A sprinkler device comprising:
i) a central body incorporating a nozzle in communication with a water inlet;
ii) a deflector assembly having at least one substantially. Radially extending spray groove, the deflector assembly being loosely coupled to the body and located in use, on a path of a jet projecting from the nozzle.

2. The sprinkler device of claim 1 wherein at least one vane is connected to the deflector assembly and extends in a direction having a radial component relative to the deflector assembly.

3. The sprinkler device of claim 2 wherein a plurality of vanes are distributed evenly about the deflector assembly.

4. The sprinkler device of claim 1, 2 or 3 wherein the deflector assembly is coupled to the body via a rolling ring extending around the body and held captive between flanges extending from the body.

5. The sprinkler device of claim 4 wherein deflecting surfaces of the deflector assembly are connected to the rolling ring via connecting columns.

6. The sprinkler device of claim 5 wherein the vanes are mounted to the rolling ring or connecting columns.

7. The sprinkler device of claim 6 wherein curved generally radial fan vanes extend from the rolling ring.

8. The sprinkler device of claim 7 wherein the curved vanes are arranged to act as a radial fan drawing air into the sprinkler and creating air flow over the spray cone.

9. The sprinkler device of claim 8 wherein there are six curved vanes extending from the rolling ring.

10. The sprinkler device as claimed in any one of claims 1 to 9 wherein the deflecting surfaces comprise a spray cone in which a plurality of radially extending grooves are formed extending from an apex of the cone.

11. The sprinkler device of claim 10 wherein vanes are mounted directly to the spray cone.

12. The sprinkler device of claim 10 wherein some vanes extend from the spray cone and additional vanes extend from the rolling ring.

13. The sprinkler device of claim 11 or 12 wherein flat radial vanes extend from the spray cone

14. The sprinkler device of claim 13 wherein there are three flat radial vanes extending from the spray cone

15. The sprinkler device as claimed in any one of claims 10 to 14 wherein the spray cone is provided with at least two substantially radially extending spray grooves, providing different water paths and resultant exit trajectories from the spray head.

16. The sprinkler device of claim 15 wherein one water path has a lower angle of trajectory while the other has a higher angle of trajectory.

17. The sprinkler device of claim 16 wherein water paths having two different exit trajectories are provided on opposing sides of the spray cone.

18. The sprinkler device as claimed in any one of claims 15 to 17 wherein more that two different exit trajectories are provided.

19. The sprinkler device as claimed in any one of claims 15 to 17 wherein six spray grooves are provided three providing a first exit trajectory and three providing a second exit trajectory.

20. The sprinkler device of claim 1, wherein the deflector assembly has at least two substantially radially extending spray grooves providing different water paths and resultant exit trajectories from the spray head, the deflector assembly being loosely coupled to the body and located in use, on a path of a jet projecting from the nozzle.

21. The sprinkler device of claim 20 wherein the deflecting surfaces comprise a spray cone in which a plurality of substantially radially extending grooves are formed extending from an apex of the cone, including said at least two substantially radially extending spray grooves providing different water paths and resultant exit trajectories from the spray head.

22. The sprinkler device of claim 20 or 21 wherein one of the at least two water paths has a lower angle of trajectory while the other has a higher angle of trajectory.

23. The sprinkler device of claim 22 wherein water paths having two different exit trajectories are provided on opposing sides of the spray cone.

24. The sprinkler device as claimed in any one of claims 20 to 23 wherein more that two different exit trajectories are provided.

25. The sprinkler device as claimed in any one of claims 20 to 23 wherein six spray grooves are provided three providing a first exit trajectory and three providing a second exit trajectory.
